(19) United States
(12) Patent Application Publication
(10) Pub. No.: US 2013/0138415 A1
(43) Pub. Date: May 30, 2013

(54) METHOD AND MODEL FOR MONITORING PRETREATMENT PROCESS OF LOW-K BLOCK LAYER

(71) Applicant: Shanghai Huali Microelectronics Corporation, Shanghai (CN)

(72) Inventors: Meimei GU, Shanghai (CN); Jian LI, Shanghai (CN); Jingchun ZHANG, Shanghai (CN)

(73) Assignee: SHANGHAI HUALI MICROELECTRONICS CORPORATION, Shanghai (CN)

(21) Appl. No.: 13/690,245

(22) Filed: Nov. 30, 2012

(30) Foreign Application Priority Data
Nov. 30, 2011 (CN) 201110392783.9

(51) Int. Cl. G06F 17/18

(52) U.S. Cl. CPC G06F 17/18
USPC 703/12; 702/179

(57) ABSTRACT

The present invention provides a method and model for monitoring the pretreatment process of a low-k block layer. The method comprises measuring film parameters of the film formed on the silicon substrate after applying the pretreatment process for different time periods; creating a statistical process control curve according to the film parameters; setting a SPC control limit; determining the pretreatment process normal when the data point of measurement in the SPC curve is within the control limit while determining the pretreatment process abnormal when the data point of measurement in the SPC curve exceeds the control limit. According to the present invention, the failure of the pretreatment process can be prevented to improve the product reliability and stability.

### CROSS-REFERENCE TO RELATED APPLICATION

This application claims the priority benefit of China application serial no. 201110392783.9, filed Nov. 30, 2011. All disclosure of the China application is incorporated herein by reference.

### FIELD OF THE INVENTION

The present invention relates to the field of semiconductor manufacturing technology, and particularly to a method and model for monitoring the pretreatment process of a low-k block layer.

### BACKGROUND OF THE INVENTION

In the application of the copper interconnection technology to the semiconductor process, a low-k block thin film is deposited between the copper interconnection and the low-k dielectric layer as a block layer during the Damascene etching process for the dielectric layer. In the semiconductor industry, the main low-k block film types are the NDC (Nitrogen-doped carbon) film and the N-Block film. Since the copper is easy to be oxidized to form copper dioxide on the surface thereof when exposed to air, it is necessary to perform a pretreatment process before the low-k block layer deposition to remove the copper oxide layer, so as to ensure a strong adhesion of the low-k block layer and the copper interconnection, as well as to ensure the adhesion of the dielectric layer and the copper interconnection.

The conventional monitoring for the low-k block layer only concentrates on the thin film property thereof, however the thin film property of the low-k block layer is almost not affected by the pretreatment process, and thus the pretreatment effect cannot be obtained by merely monitoring the thin film property of the low-k block layer. Once problems such as process failure occur in the pretreatment process, it can only be found on the manufactured product (for example, the peeling of the thin film between the low-k barrier layer and the copper interconnection), and the surface copper oxide layer cannot be removed. Consequently, the reliability and stability of the products will be affected, which may cause the potential device failure and loss of the profit in the fabrication of the semiconductor.

FIG. 1 is a schematic diagram of a copper interconnection structure with a low-k block layer 3. Referring to FIG. 1, after the CMP process for the copper interconnection 2 on the substrate 1, a pretreatment process is performed before the low-k block layer 3 deposition. The failure in the pretreatment process may affect the adhesion of the dielectric layer 4 and the copper interconnection 2 directly so as to reduce the reliability and stability of the product.

### SUMMARY OF THE INVENTION

Accordingly, at least one objective of the present invention is to provide a new monitoring method and model for the pretreatment effectiveness of the low-k block layer deposition process which not only monitors the property of the low-k block film, but also monitors and controls the pretreatment process. Therefore, the invalidation of the pretreatment process can be prevented, and the shortage of the conventional monitoring method can be compensated. Furthermore, the adhesion of the copper interconnection between the low-k dielectric layer can be well controlled, so as for the product reliability and stability control and improvement.

To achieve these and other advantages and in accordance with the objective of the invention, as embodied and broadly described herein, the invention provides a new method for monitoring the pretreatment process of a low-k block layer comprising: measuring the film parameters of the film formed on the silicon substrate after applying the pretreatment process for different time periods; creating an SPC (Statistical Process Control) curve according to the film parameters; setting a control limit for the SPC curve; determining the pretreatment process normal when the data point of measurement in the SPC curve is within the control limit while determining the pretreatment process abnormal when the data point of measurement in the SPC curve exceeds the control limit.

The invention further provides a model for monitoring the pretreatment process of a low-k block layer. The model comprises a testing unit for measuring the film parameters of the film formed on a silicon substrate respectively after the silicon substrate being applied by the pretreatment process for different time periods; a modeling unit for creating an SPC (Statistical Process Control) curve according to the film parameters; a setting unit for setting a control limit for the SPC curve; and a determination unit, wherein the determination unit determines the pretreatment process normal when the data point of measurement in the SPC curve is within the control limit while determines the pretreatment process abnormal when the data point of measurement in the SPC curve exceeds the control limit.

According to the monitoring method and model for the pretreatment process of a low-k block film deposition of the present invention, the pretreatment process failure can be prevented effectively and the product reliability and stability can be improved greatly.

### BRIEF DESCRIPTION OF THE DRAWINGS

The monitoring method and model for the pretreatment process of a low-k block film of the present invention will be elucidated by reference to the following embodiments and the accompanying drawings, in which:

FIG. 1 is a sectional view showing a copper interconnection structure with a low-k block layer;

FIG. 2 is a comparison diagram showing a low-k block film thickness with the pretreatment process in experiment 1 and a low-k block film thickness without the pretreatment process in experiment 2;

FIG. 3 is a comparison diagram showing a low-k block film refraction index with the pretreatment process in experiment 1 and a low-k block film refraction index without the pretreatment process in experiment 2;

FIG. 4 is a comparison diagram showing the thickness of the film growing on the bare silicon substrate with the single pretreatment process lasting for 12 seconds in experiment 3, the thickness of the film growing on the bare silicon substrate with the single pretreatment process lasting for 60 seconds in experiment 4 and the film thickness of the film growing on the bare wafer without the pretreatment process in experiment 5.

FIG. 5 is a schematic flow chart showing the monitoring method for the pretreatment process of a low-k block film deposition in one embodiment of the present invention;

FIG. 6 is a schematic diagram of the monitoring model for the pretreatment process of a low-k block film deposition in one embodiment of the present invention.

### DETAILED DESCRIPTION OF THE EMBODIMENTS

The method and model for monitoring the pretreatment process of a low-k block layer of the present invention will be described in further details hereinafter with respect to the embodiments and the accompanying drawings. However, the embodiments described herein are not the only applications or uses contemplated for the invention. The specific embodiments discussed are merely illustrative of specific ways to make and use the invention, and do not limit the scope of the invention or the appended claims.

Chart 1 illustrates a conventional method for monitoring the low-k block thin film in the copper interconnection process.

CHART 1

| Test Item | Monitoring object | Process Step | Test Parameter |
|---|---|---|---|
| 1 | low-k block thin | pretreatment | particle size of the |
| | film | process + low-k | film, film thickness, |
| | | block thin film | refractive index of the |
| | | deposition | film, film stress |

According to the monitoring method in an embodiment of the present invention, a monitoring for a single pretreatment process is added, and the monitoring method can be illustrated in Chart 2 as follows:

CHART 2

| Test Item | Monitoring object | Process Step | Test Parameter |
|---|---|---|---|
| 1 | low-k block thin | pretreatment | particle size of the |
| | film | process + low-k | film, film thickness, |
| | | block thin film | refractive index of |
| | | deposition | the film, film stress |
| 2 | pretreatment | pretreatment | film thickness |
| | process | process only | |
| | | (without depositing | |
| | | the low-k block | |
| | | thin film) | |

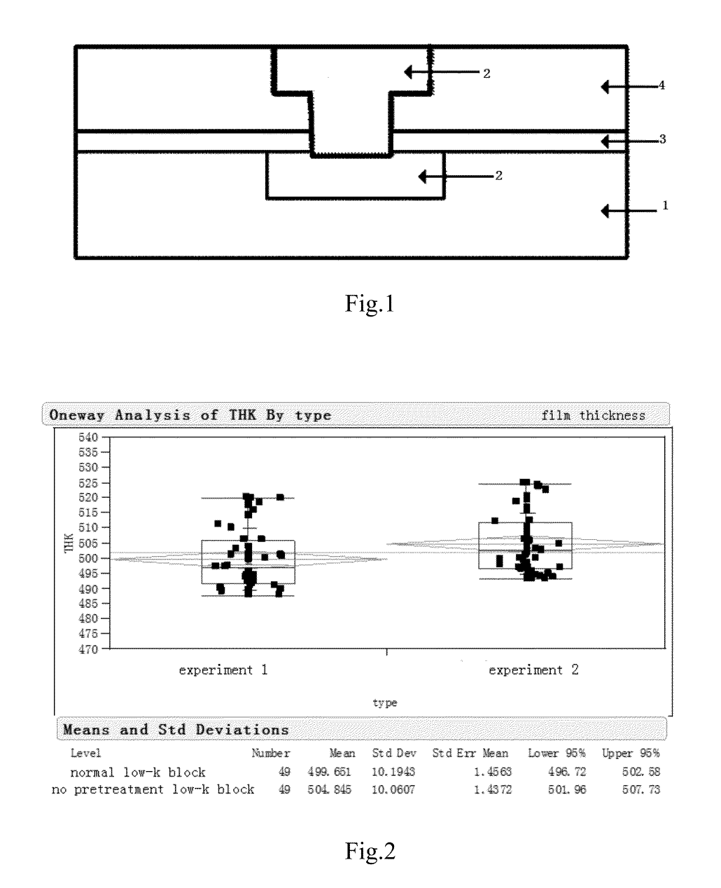

Compared with the conventional monitoring method, the present invention provides a method for monitoring the pretreatment process of a low-k block layer. To be specific, during the fabrication of the copper interconnection structure (as shown in FIG. 1), a process equipment (such as a CVD equipment) is used for depositing the low-k block layer with the pretreatment step, the process equipment can be monitored by performing a pretreatment process on a bare wafer (silicon substrate) individually in the reaction chamber periodically (such as on a 24-hour cycle). The film parameters such as the film thickness on the bare wafer are measured to determine the normality of the process equipment as well as the normality of the pretreatment process. Furthermore, the bare wafer is utilized in the monitor instead of the production wafer, which can reduce the monitoring cost. The present invention can monitor the normality of the pretreatment process and the related equipment effectively by adding a monitoring item of the pretreatment process so as to prevent the process invalidation of the pretreatment process and increase the stability of adhesion strength between the copper interconnection and the low-k dielectric layer.

In the actual manufacturing process of the semiconductor products, the pretreatment process before the deposition of the low-k block layer utilizes ammonia (NH₃) to react with the copper oxide under plasma environment to deoxidize the copper and remove the surface oxide layer of the copper. While during the periodical monitoring for the bare wafer of the present invention, the ammonia will react with the silicon under plasma environment to form a silicon nitride thin film on the wafer, thus an indirect monitoring for the pretreatment process can be realized through monitoring the thin film parameters such as the film thickness of the silicon nitride after applying varied time periods of the pretreatment process. For example, when the thickness of the silicon nitride thin film increases to a certain degree, it can be determined that the copper oxide in the product has been deoxidized completely and the pretreatment process is normal.

Then, create an SPC (statistical process control) curve according to the film parameters of the silicon nitride thin film obtained by performing single pretreatment processes (for example, the sampling number of the parameters of the pretreatment process can be equal to or greater than thirty to ensure accuracy) on the bare wafer, and set a control limit and perform regular monitoring. In a preferred embodiment, the film parameter is the film thickness, and the control limit is ±3 sigma. If the monitoring result of the film thickness is within ±3 sigma control, the pretreatment process is determined to be normal; if the monitoring result of the film thickness exceeds ±3 sigma control, the pretreatment process is determined to be abnormal, the pretreatment equipment should be stopped to avoid affecting more product, and the further examining check for the failure or instability of the pretreatment process should be taken.

The SPC is used for monitoring the manufacturing process by statistical technique and warning immediately when an abnormality happens during the manufacturing process through the collection and the analysis of the tested statistics. Therefore, immediate measures can be taken to eliminate the abnormalities and restore the stable manufacturing process so as to improve the product quality. Furthermore, “sigma” indicates standard deviation σ in statistics herein, and the standard deviation σ shows the dispersion of the statistic from the average and usually can be used to reduce the defects of the products and the process during the fabrication.

In addition, through the experiments, it is found that the pretreatment process has great impact on the film thickness of the silicon nitride film while the influence on the refractive index of the silicon nitride film can be neglected; therefore the SPC curve can be created according to the film thickness measured in the experiments 3 to 5.

For example, five experiments for monitoring the low-k block thin film on the bare wafer are applied respectively, wherein,

In experiment 1: the normal low-k block thin film deposition with the pretreatment process in ahead, means “pretreatment process+low-k block thin film deposition”;

In experiment 2: the special low-k block thin film deposition without the pretreatment process in ahead, means “only low-k block film deposition”;

In experiment 3: the single pretreatment process on the bare wafer for 12 seconds means “only pretreatment 12 sec”;

In experiment 4: the single pretreatment process on the bare wafer for 60 seconds means “only pretreatment 60 sec”;

In experiment 5: none of the process is applied to the bare wafer.

The specific experiment results are illustrated in FIGS. 2 to 4.

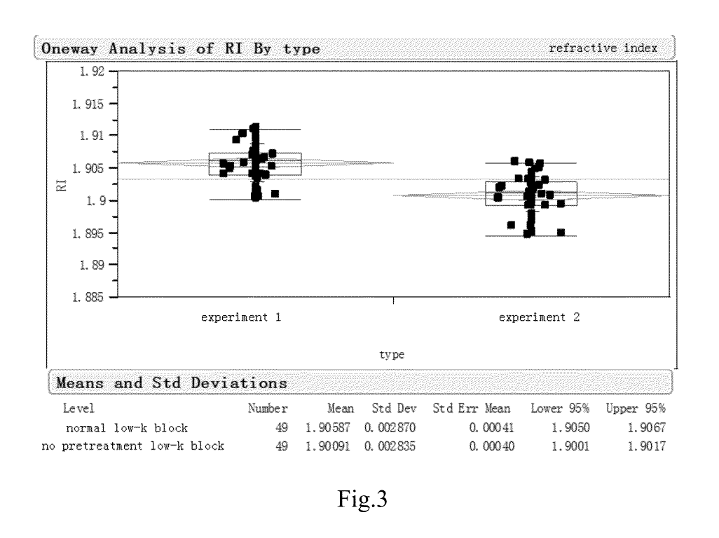

The chart 3 illustrates the experimental data in FIG. 2 and FIG. 3.

CHART 3

| | Experiment 1 | Experiment 2 | Percentage difference |
|---|---|---|---|
| Film thickness | 499.65 Å | 504.85 Å | 1% |
| Refractive | 1.9059 | 1.9091 | 0.17% |
| index | | | |

As can be seen from the above experiment results, the film thickness of the low-k block thin films are almost the same with merely a difference of 5 Å (1%); the refractive indexes of the low-k block thin films are almost the same with merely a difference of 0.005 (0.17%). Therefore, with or without the pretreatment process has almost no impact on the property of the low-k block thin film. This means the pretreatment process effect cannot be determined by merely monitoring the property of the low-k block thin film if the monitoring result is within the range of the SPC curve. Consequently, the failure of the pretreatment process cannot be reflected in the monitoring results of the property of the low-k block thin film, which may affect the adhesion of the copper interconnection and the dielectric layer and even the reliability and stability of the product.

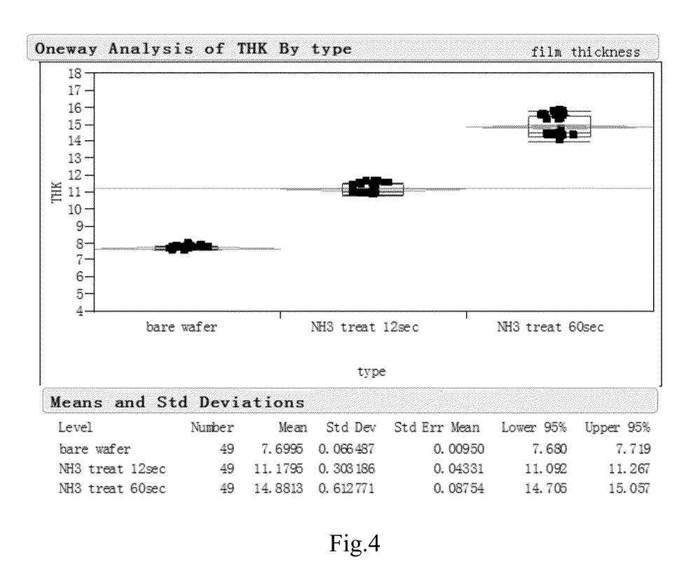

Chart 4 illustrates the experimental data shown in FIG. 4.

| | Experiment 5 | Experiment 3 | Experiment 4 |
|---|---|---|---|
| Film thickness | 7.6 Å | 11.2 Å | 14.9 Å |

In experiments 3 to 5, the single pretreatment process is applied to the bare wafer for different time periods. It can be seen that the pretreatment time has a direct relationship with the film parameter (such as the film thickness of the silicon nitride thin film formed on the bare wafer). To be specific, during the monitoring for the pretreatment process, the ammonia will react with the silicon under plasma environment to form a silicon nitride thin film on the bare wafer (i.e. silicon substrate), and the thickness of the silicon nitride will increase with the reaction time of the ammonia plasma (i.e. pretreatment time).

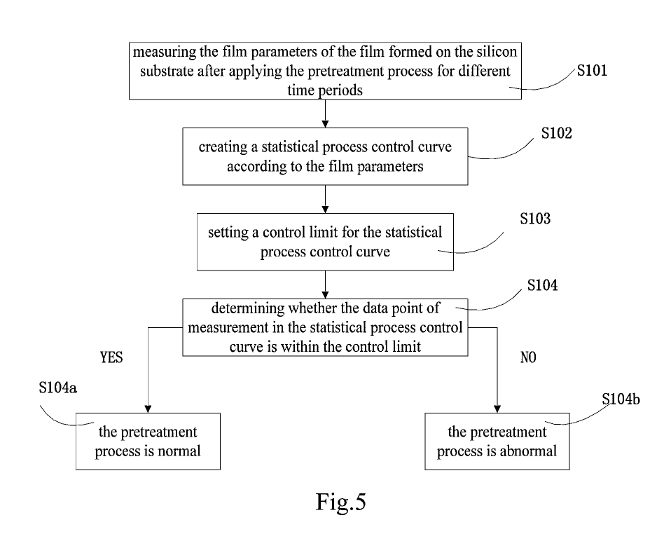

FIG. 5 is a flow chart showing the method for monitoring the pretreatment process of a low-k block layer in one embodiment. As shown in FIG. 5, the method comprises: step S101, measuring the film parameters of the film formed on the silicon substrate after applying the pretreatment process for different time periods, the film parameters can be the film thickness of the silicon nitride film formed on the silicon substrate; step S102: creating an SPC (Statistical Process Control) curve according to the film parameters; step S103, setting a control limit for the SPC curve(such as ±3 sigma); step S104, determining the normality of the pretreatment process, if the data point of measurement in the SPC curve is within the control limit the pretreatment is normal S104a; if the data point of measurement in the SPC curve exceeds the control limit, the pretreatment is abnormal S104b. Thus it can be determined whether the copper dioxide has been deoxidized successfully and completely, which means whether the process pretreatment is normal or abnormal. Therefore, the failure of the process pretreatment which may affect the adhesion strength of the low-k dielectric layer and the copper interconnection and the reliability and stability of the product can be prevented.

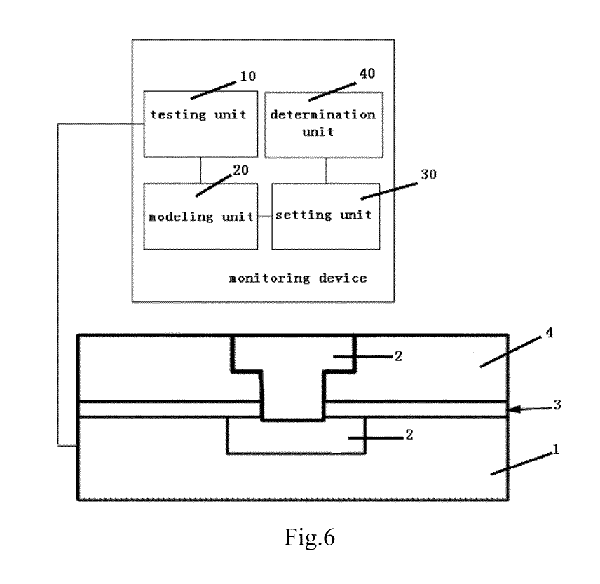

The present invention further provides a model for monitoring the pretreatment process for forming a low-k block layer. As shown in FIG. 6, the device comprises a testing unit 10 for measuring the film parameters of the film formed on the silicon substrate after the silicon substrate being applied by the pretreatment process for different time periods respectively; a modeling unit 20 for creating an SPC (Statistical Process Control) curve according to the film parameters; a setting unit 30 for setting a control limit for the SPC curve; and a determination unit 40, wherein the determination unit 40 determines the pretreatment normal when the data point of measurement in the SPC curve is within the control limit while determines the pretreatment abnormal when the data point of measurement in the SPC curve exceeds the control limit.

The model can be performed in software or in any combination of software and hardware.

Although the present invention has been disclosed as above with respect to the preferred embodiments, they should not be construed as limitations to the present invention. Various modifications and variations can be made by the ordinary skilled in the art without departing the spirit and scope of the present invention. Therefore, the protection scope of the present invention should be defined by the appended claims.

1. A method for monitoring the pretreatment process of a low-k block layer comprising:
measuring the film parameters of the film formed on a silicon substrate after applying the pretreatment process for different time periods;
creating a statistical process control curve according to the film parameters;
setting a control limit for the statistical process control curve;
determining the pretreatment process normal when the data point of measurement in the statistical process control curve is within the control limit while determining the pretreatment process abnormal when the data point of measurement in the statistical control curve exceeds the control limit.

2. The method according to claim 1, wherein the film parameter is the film thickness of the silicon nitride film formed on the silicon substrate after applying the pretreatment process.

3. The method according to claim 1, wherein the pretreatment process comprises:
utilizing ammonia to react with the silicon substrate under plasma environment to form the silicon nitride film on the silicon substrate.

4. The method according to claim 1, wherein the low-k block layer is a nitrogen-doped carbon film.

5. The method according to claim 1, wherein the statistical process control curve is created according to no less than 30 film parameters.

6. The method according to claim 1, wherein the control limit is ±3 sigma.

7. A model for monitoring the pretreatment process of a low-k block layer comprising:
a testing unit for measuring the film parameters of the film formed on a silicon substrate respectively after the silicon substrate being applied by the pretreatment process for different time periods;
a modeling unit for creating a statistical process control curve according to the film parameters;
a setting unit for setting a control limit for the statistical process control curve; and
a determination unit, wherein the determination unit determines the pretreatment process normal when the data point of measurement in the statistical process control curve is within the control limit while determines the pretreatment process abnormal when the data point of measurement in the statistical process control curve exceeds the control limit.

8. The model according to claim 7, wherein the film parameter is the film thickness of the silicon nitride film formed on the silicon substrate after the silicon substrate being applied by the pretreatment process.

9. The model according to claim 7, wherein the pretreatment process comprises: utilizing ammonia to react with the silicon substrate under plasma environment to form the silicon nitride film on the silicon substrate.

10. The model according to claim 7, wherein the low-k block layer is a nitrogen-doped carbon film.

11. The model according to claim 7, wherein the statistical process control curve is created according to no less than 30 film parameters.

12. The model according to claim 7, wherein the control limit is ±3 sigma.
